(19) United States
(12) Patent Application Publication
(10) Pub. No.: US 2005/0044218 A1
(43) Pub. Date: Feb. 24, 2005

(54) Multidomain access control of data flows associated with quality of service criteria

(76) Inventor: Alban Couturier, Chatillon (FR)

Correspondence Address: SUGHRUE MION, PLLC, 2100 PENNSYLVANIA AVENUE, N.W., SUITE 800, WASHINGTON, DC, 20037, US

(21) Appl. No.: 10/497,027

(22) PCT Filed: Nov. 25, 2002
(86) PCT No.: PCT/FR02/04028

(30) Foreign Application Priority Data
Nov. 29, 2001 (FR) 01/15430

(51) Int. Cl. G06F 15/173

(52) U.S. Cl. 709/225; 709/224

(57) ABSTRACT

The invention concerns an access controller (AC₁, AC₂) to a domain (N₁, N₂) of a data network, including a set of routers (R₁, R₂, , R₅) characterized in that it includes: a receiver for receiving a quality of service request (m₂) containing data concerning the input point of the packet flow associated with the request in the domain; a component for determining an output point corresponding to the request; and a transmitter for transmitting a modified request (m₃) to the access controller associated with the output domain corresponding to the output point, by inserting therein data concerning the input point of the packet flow in the output domain.

The present invention relates to managing quality of service in a data network. It applies particularly to data networks made up of a plurality of domains, providing different services, such as transmission of voice, data, video, etc. A network of this kind may be based on the Transport Control Protocol/Internet Protocol (TCP/IP) family, for example, i.e. of the type usually called Internet protocols.

Certain services necessitate explicit reservation of resources within the network.

In fact, some networks, such as the Internet, have been designed to transmit data but neither voice nor video. Within the Internet, transmission takes the form of packets, each packet being routed independently of the others. Now, the transmission of voice and video, for example, necessitates minimizing the packet loss ratio and the transmission delay, to ensure sufficiently comfortable listening and viewing for the receiver of the transmission.

Jitter and delay are conventionally minimized by reserving resources in nodes (or routers) of the network.

Conventionally, a terminal requiring a certain quality of service for a certain flow transmits a quality of service request before sending the packets corresponding to the flow.

Hereinafter, the term “flow” signifies a “microflow”, i.e. a set of packets conventionally characterized by the following quintuple of information: the protocol used, the address and the port of the sender, and the address and the port of the receiver.

This quality of service request is generally a resource reservation request, for example conforming to the ReSerVation Protocol (RSVP) as defined by Request For Comments (RFC) 2205 of the Internet Engineering Task Force (IETF).

According to the RSVP, each router receiving a resource reservation request must first verify if it has the requested resources and route the request in accordance with conventional routing algorithms. The resource reservation request therefore follows the path that will normally be that of the packets of the flow, as far as the receiver, which then sends a response to the original sender that travels back along the same path. During this second passage, each router must actually reserve the requested resources.

This protocol has a major drawback in that it necessitates, for each quality of service request addressed to a network, reserving resources on a large set of routers and, in practice, maintaining a processing context within each router.

This drawback is removed by the Differentiated Services model (DiffServ) architecture as defined by IETF RFC 2475.

According to this architecture, the quality of service requests are executed by assigning priorities, which are called colors in this context, to each packet of the flow. Routers receiving packets that have been “colored” in this way (i.e. to which a priority has been assigned) must give priority to processing them.

However, these two solutions are complementary with the result that the prior art solutions may use both protocols simultaneously, to exploit their respective advantages.

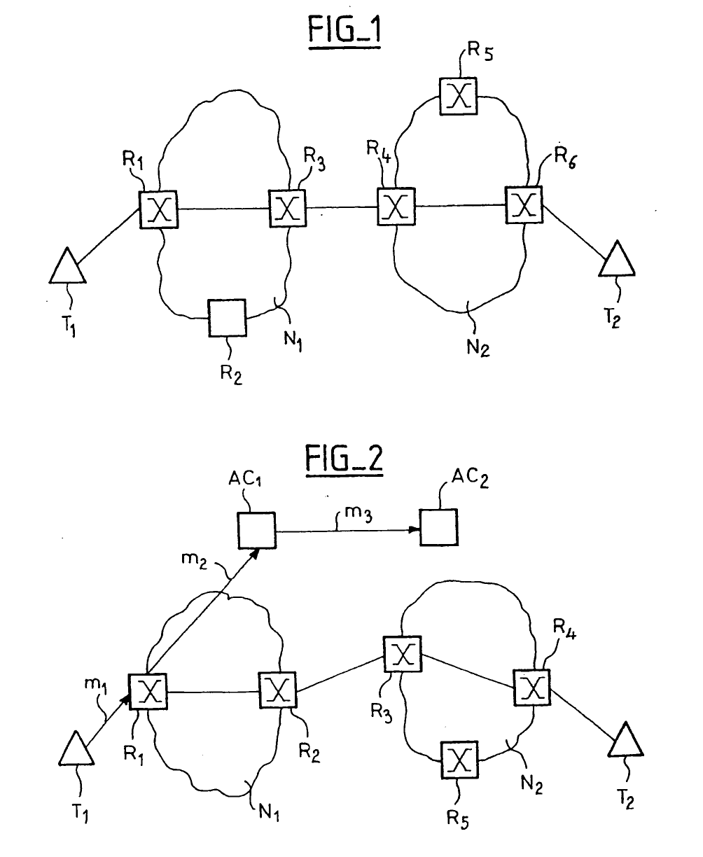

FIG. 1 shows one embodiment of a prior art solution of the above kind. This prior art is described, for example, in RFC 2998 “A Framework for Integrated Services Operation over Diffserv Networks” adopted by the IETF in November 2000.

A terminal T₁ is connected to a domain N₁ comprising routers R₁, R₂ and R₃. A terminal T₂ is connected to a domain N₂ comprising routers R₄, R₅, R₆.

If the terminal T₁ wishes to transmit a flow of data necessitating a certain quality of service to the terminal T₂ (for example, a multimedia session that necessitates a minimum bit rate), it sends an RSVP resource reservation request.

The resource reservation request is received and then processed by the router R₁. It verifies that it actually has sufficient internal resources (i.e. an output bit rate value above a threshold specified by the resource reservation request).

Where appropriate, the resource reservation request is transmitted to the next router, which may process it, up to the boundary of the DiffServ network. The response is conventionally returned to the router R₁, which may then transmit it to the terminal T₁, thereby informing it that resources have actually been reserved.

The terminal T₁ then transmits the packets of the flow to the destination terminal T₂.

On receiving them, the router R₁ assigns them a priority as a function of the resource reservation request previously received.

As previously stated, the assignment of priority conventionally conforms to the DiffServ architecture.

The priority packets are then routed within the domain N₁ and then the domain N₂, passing through the routers R₁, R₃, R₄ and R₆. Each of these routers processes the packets as a function of the priorities assigned to them.

This prior art solution encounters a major problem in that the verification of the resources available is effected only by the first router R₁. Thus if two quality of service requests are initiated at two different edge routers, for example the routers R₁ and R₂ or the routers R₁ and R₅, the result may be that it is not possible to detect that another router is unable to satisfy this quality of service requirement. Both quality of service requests will then be granted, although only one of them, or even both of them, cannot be satisfied.

The object of the invention is to solve this problem, in particular when several domains are concerned.

To this end, the invention proposes to transfer the available resources verification function to a single device called the administration controller.

To be more precise, the invention consists in an admission controller for controlling admission to a domain of a data network, said domain having a set of routers, which controller is characterized in that it has:
receiver means for receiving a quality of service request containing information relating to the entry point of the flow of packets associated with said quality of service request into said domain,
determination means for determining an exit point corresponding to said quality of service request, and
transmission means for transmitting a modified quality of service request to the admission controller associated with the exit domain corresponding to said exit point, inserting therein information relating to the entry point of said flow of packets into said exit domain.

In one embodiment of the invention the admission controller further comprises verification means for determining if said quality of service request can be satisfied by said domain.

For example, said determination may be effected as a function of a knowledge of the resources used in said domain or in accordance with a macroscopic heuristic.

By centralizing all the quality of service requests addressed to a domain at a single admission controller, the latter is able to know the use that is being made of the resources of the domain and therefore to grant or refuse quality of service requests without giving rise to the problems of the prior art previously mentioned.

The admission controllers of the various domains may exchange information on the quality of service requests. In particular, they send each other information relating to the entry point of the flows of packets associated with the quality of service requests, in order to be able to determine the routing for those flows of data.

The invention and its advantages will become more clearly apparent in the course of the following description, which is given with reference to the appended drawings.

FIG. 1, already commented on, represents prior art admission control in a network formed of a plurality of domains.

FIG. 2 depicts one embodiment of the invention using centralized admission controllers.

In the FIG. 2 example, the terminal T₁ wishes to initiate a multimedia session with the terminal T₂. The terminal T₁ is attached to a domain N₁ and the terminal T₂ is attached to a domain N₂.

The multimedia session necessitates a certain quality of service. The terminal T₁ therefore sends a quality of service request m₁ to the router R₁ to which it is attached.

This quality of service request m₁ typically conforms to the RSVP.

It is nevertheless important to note that the invention may also be used in the context of a purely “DiffServ” network.

According to the invention, this router (or any other equipment) R₁ intercepts the quality of service request and sends it to the admission controller AC₁ in the form of a message m₂. This quality of service request m₂ may conform to the COPS protocol, for example, as defined by RFC 2748 “The COPS (Common Open Policy Service)”, adopted by the IETF in January 2000.

The router R₁ may insert into the request information characterizing it, for example its Internet Protocol (IP) address, but generally the admission controller AC₁ itself has sufficient knowledge to associate this information with the quality of service request.

The admission controller AC₁ is associated with the domain N₁.

It has receiver means for receiving the quality of service request m₂ and for acquiring information relating to the entry point of the flow of packets associated with the quality of service request into the domain N₁. It is therefore able to tell that the flow of data has reached the router R₁.

The admission controller AC₁ has means for determining an exit point of the flow of packets corresponding to the quality of service request.

The determination means may comprise their knowledge of the internal resources of the domain N₁ and more particularly the topology of the routers constituting it.

Knowing that topology, and the entry point of the quality of service request, the admission controller AC₁ may determine the corresponding exit point. To this end, it may simply determine the path by looking for the next router, router by router. This can be done by resolving the Internet Protocol (IP) address that is the destination of the flow of packets with the routing tables of the routers that it has recovered with the topology of the network. It may also determine the exit point from its knowledge of all the Border Gateway Protocol (BGP) routing information circulating between the edge routers of the domain.

In the case of a network configured to represent border to border label switch paths, for example of the Multi-Protocol Label Switching (MPLS) type, only the label switch path needs to be known to determine the exit point. To this end, the admission controller must know the routing table and the rules for determining the label switch path in the router.

Knowing this exit point, it may determine the exit domain on the one hand, and the entry point into the exit domain on the other hand. In the FIG. 2 example, the exit domain is the domain N₂ and the entry point belongs to the router R₄.

The entry point into the exit domain is characterized by the identifier of the input router R₃ (for example its IP address). Depending on the quality of service (QoS) architecture employed, it may be characterized, in addition to the identifier of the router, by level 1 or level 2 information in the sense of the Open Systems Interconnection (OSI) model, for example an identifier of the physical card, of the ATM virtual circuit, a multi-protocol label switching (MPLS) label, etc.

This information relating to the entry point into the exit domain is inserted into a modified quality of service request m₃ transmitted to the admission controller AC₂ associated with the exit domain N₂.

The admission controller AC₂ therefore receives a quality of service request m₃ comprising the entry point into its domain. It may therefore determine its exit point.

If the flow of data conveying the multimedia session had to cross a greater number of domains, the quality of service request would be transmitted in this way from admission controller to admission controller.

In one embodiment of the invention, the admission controllers (or some of them) may further comprise verification means for determining if the quality of service request can be satisfied by its associated domain.

In a first embodiment, this determination may be effected as a function of knowledge of the resources used in the domain. These internal resources may be supplied by a network management system. They may in particular comprise bandwidths of the connections (or of some of the connections) between the routers constituting the domain.

In a second embodiment, this determination may be effected in accordance with a macroscopic heuristic. The heuristic may simply consist in considering that the domain may satisfy a predetermined number of quality of service requests. The determination then consists simply in counting the number of quality of service requests received (and still in force) and verifying that this number remains below the number defined beforehand.

If an admission controller determines that the quality of service request cannot be satisfied, it can stop it propagating toward the next admission controller: this is because, for the required quality of service to be achieved, it is necessary for all the domains crossed to be able to satisfy the quality of service request.

It may then send a response message to the admission controller that sent it the quality of service request to advise it of the non-satisfaction of the quality of service request.

The latter admission controller may then choose another domain to attempt to route the flow of packets to the destination.

If all the admission controllers of the chain decide that their corresponding domain can satisfy the quality of service request, the last one in the chain sends the preceding admission controller a response message advising that the quality of service request has been satisfied.

This response message propagates in the opposite direction to the quality of service request, as far as the first admission controller, and then to the router at which the quality of service request arrived.

That router is then sure that the quality of service requested by the terminal can be satisfied as far as the destination terminal(s). It may then authorize transmission of the flow of data corresponding to the multimedia session.

1. Admission controller (AC₁, AC₂) for controlling admission to a domain (N₁, N₂) of a data network, said domain having a set of routers (R₁, R₂ . . . R₅), which controller is characterized in that it has:
receiver means for receiving a quality of service request (m₂) containing information relating to the entry point of the flow of packets associated with said quality of service request into said domain,
determination means for determining an exit point corresponding to said quality of service request, and
transmission means for transmitting a modified quality of service request (m₃) to the admission controller associated with the exit domain corresponding to said exit point, inserting therein information relating to the entry point of said flow of packets into said exit domain.

2. Admission controller according to claim 1, further comprising verification means for determining if said quality of service request can be satisfied by said domain.

3. Admission controller according to claim 1, wherein said determination is effected as a function of a knowledge of the resources used in said domain.

4. Admission controller according to claim 2, wherein said determination is effected in accordance with a macroscopic heuristic.
